(19) United States
(12) Patent Application Publication
(10) Pub. No.: US 2010/0007976 A1
(43) Pub. Date: Jan. 14, 2010

(54) PROTECTING MAGNETIC HEAD ELEMENTS

(76) Inventors: Peter M. Baumgart, San Jose, CA (US); Wen-chien D. Hsiao, San Jose, CA (US); Fu-Ying Huang, San Jose, CA (US); Jia-Yang Juang, Santa Clara, CA (US)

Correspondence Address: HITACHI C/O WAGNER BLECHER LLP, 123 WESTRIDGE DRIVE, WATSONVILLE, CA, 95076, US

(21) Appl. No.: 12/170,168

(22) Filed: Jul. 9, 2008

(51) Int. Cl. G11B 27/36; G11B 5/33; B05D 5/00

(52) U.S. Cl. 360/31; 360/110; 427/58; 427/8

(57) ABSTRACT

A magnetic head is described herein. A method for manufacturing the magnetic head comprises determining a protective distance for a protective structure to extend beyond an element in a direction toward a disk, layering the protective structure, and removing material from the protective structure to obtain approximately the protective distance. The protective distance is from an element end to a protective structure end. The protective distance is determined based on a magnetic head profile. The thickness of the protective structure is based on pole-tip recession.

### TECHNICAL FIELD

Embodiments of the present technology relate generally to the field of hard disk drives.

### BACKGROUND

One approach for a thermal flying height calibration for a magnetic head is to apply a larger than operational current through a heater until the magnetic head makes physical contact with a disk. Unfortunately, such contact may cause reader or writer element failure depending on touch-down location and other factors.

One approach for avoiding the reader element and/or the writer element from contacting the disk is to control a poll-tip recession by adjusting an etching angle and lapping techniques. Unfortunately, this approach does not provide a highly repeatable and robust poll-tip recession.

### SUMMARY

Systems and methods for a magnetic head are described herein. In one embodiment, a method for manufacturing the magnetic head comprises determining a protective distance for a protective structure to extend beyond an element in a direction toward a disk, layering the protective structure, and removing material from the protective structure to obtain approximately the protective distance. The protective distance is from an element end to a protective structure end. The protective distance is determined based on a magnetic head profile. The thickness of the protective structure is based on pole-tip recession.

### BRIEF DESCRIPTION OF THE DRAWINGS

The accompanying drawings, which are incorporated in and form a part of this specification, illustrate embodiments of the presented technology and, together with the description, serve to explain the principles of the presented technology:

FIGS. 1 (PRIOR ART) and 2 (PRIOR ART) illustrate before and after views of lapping and pre-carbon etching of a magnetic head.

FIG. 3 and 4 illustrate before and after views of lapping and pre-carbon etching of a magnetic head with a protective structure, in accordance with an embodiment of the present technology.

FIG. 5 is a graph illustrating a flying-height profile for a magnetic head with a protective structure, in accordance with an embodiment of the present technology.

FIG. 6 is a flow diagram of an example method of manufacturing a magnetic head, in accordance with an embodiment of the present technology.

The drawings referred to in this description should not be understood as being drawn to scale unless specifically noted.

### DESCRIPTION OF EMBODIMENTS

Reference will now be made in detail to the alternative embodiments of the present technology. While numerous specific embodiments of the present technology will be described in conjunction with the alternative embodiments, it will be understood that they are not intended to limit the present technology to these embodiments. On the contrary, these described embodiments of the present technology are intended to cover alternatives, modifications and equivalents, which may be included within the spirit and scope of the embodiments as defined by the appended claims.

Furthermore, in the following description of embodiments, numerous specific details are set forth in order to provide a thorough understanding of the present technology. However, it will be recognized by one of ordinary skill in the art that embodiments may be practiced without these specific details. In other instances, well known methods, procedures, components, and circuits have not been described in detail as not to obscure unnecessarily aspects of embodiments of the present technology.

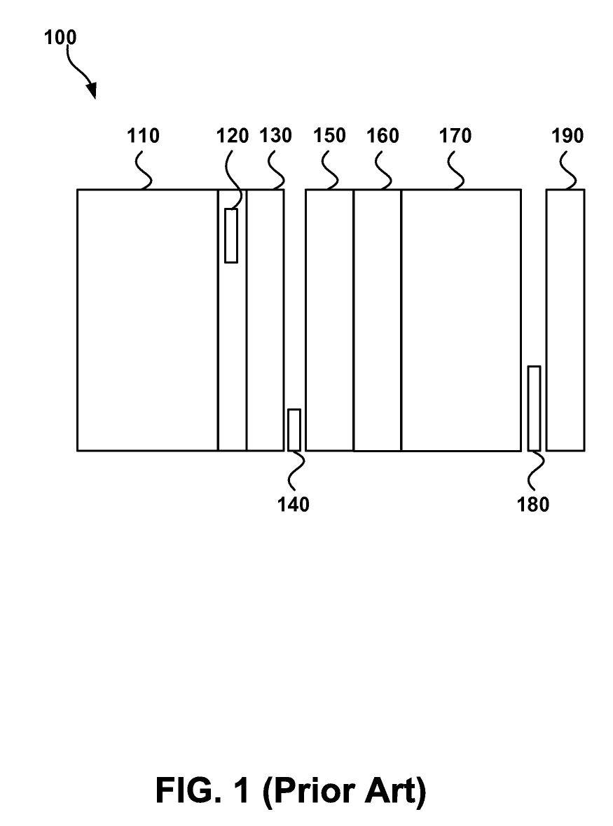

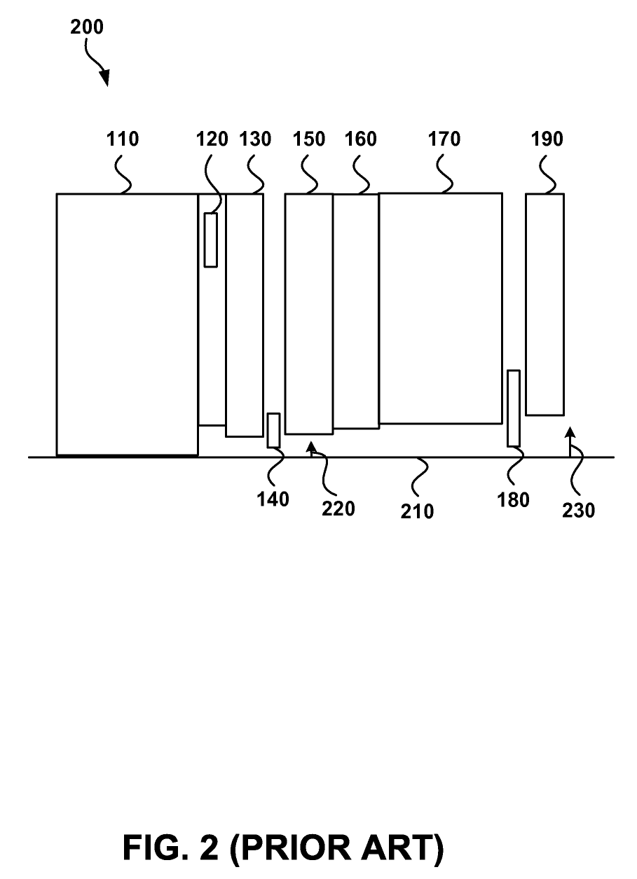

FIGS. 1 (PRIOR ART) and 2 (PRIOR ART) illustrate before and after views of lapping and pre-carbon etching of a magnetic head 100, 200, respectively. The magnetic head 100 of FIG. 1 (PRIOR ART) comprises a substrate 110, a heat element 120, a shield 130, a reader element, 140, a shield 150, a bottom poll 160, a writer assembly 170, a writer element 180, and a top pole 190.

The magnetic head 200 of FIG. 2 (PRIOR ART) illustrates the effect of lapping and pre-carbon etching of the magnetic head 100. During fabrication, a profile of a magnetic head changes as a pole tip is recessed. Pole-tip recession is mainly induced by lapping and pre-carbon etching. Lapping and pre-carbon etching may induce more erosion and/or recession for less tolerant materials. For example, the shield 150 may experience more erosion and/or recession than the bottom poll 160. Metal and alumina layers may be recessed by a couple of nanometers, depending on the different material removal rates.

Another pole-tip recession profiling factor is the location of nearby materials. Less tolerant materials may erode less if the less tolerant materials are next to and/or near more tolerant materials. This may occur as the more tolerant materials provide a shield to prevent some erosion and/or recession of the less tolerant materials.

Yet another pole-tip recession profiling factor is a distance from the substrate 110. The farther the distance the more the layer is influenced by lapping/pre-carbon etching. For example, shield 150 may experience more erosion and/or recession than shield 130 as shield 150 is farther from the substrate 110. This is illustrated by a pole-tip recession line 210 comprising recession magnitude arrows 220 and 230. The recession magnitude arrow 230, the larger arrow, is farther from the substrate 110 and thereby represented as larger than the recession magnitude arrows 220.

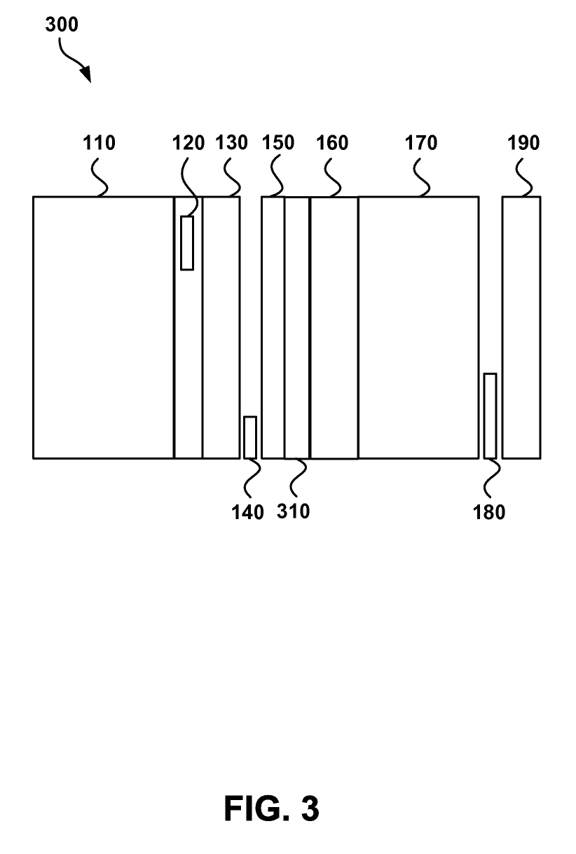

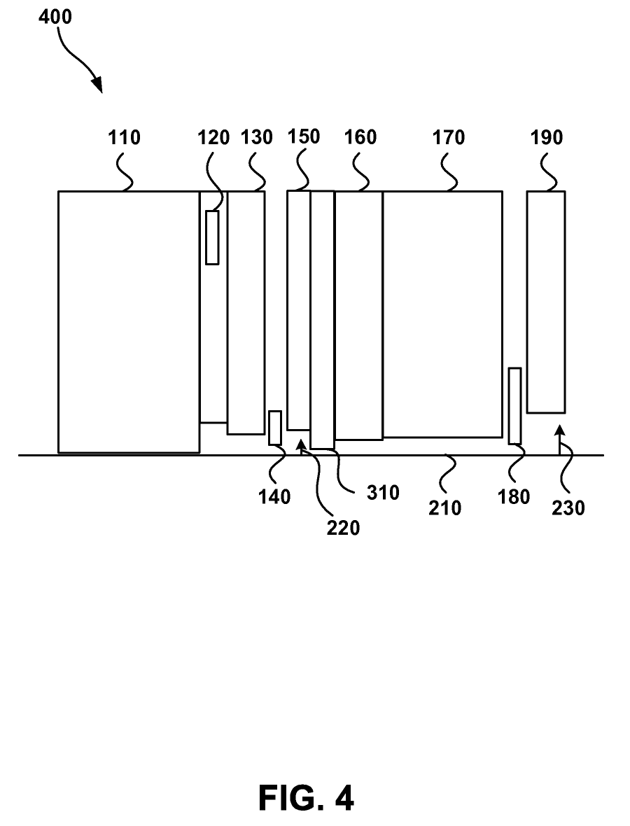

FIGS. 3 and 4 illustrate before and after views of lapping and pre-carbon etching of a magnetic head 300, 400, respectively, with a protective structure, in accordance with an embodiment of the present technology. The magnetic head 300 is similar to the magnetic head 100. The magnetic head comprises a protective structure 310. The protective structure 310 is a layer of material that is more resistant to lapping and/or pre-carbon etching than other layers. The protective structure 310 may be positioned between the substrate 110 and the top pole 190, or may be an outermost layer. The protective structure 310 may be made of silicon-carbon, tungsten, or any other more resistant material than one or more other layers used in the magnetic head 300. In various embodiments, one or more protective structures may be layered in various locations.

The magnetic head 400 of FIG. 4 illustrates the effect of lapping and pre-carbon etching of the magnetic head 300. After lapping and pre-carbon etching, the protective structure 310 may be nearer than the reader element 140 and the writer element 180. In various embodiments, the protective structure 310 is designed to make contact with a disk (not depicted), thereby preventing the reader element 140 and/or the writer element 180 from making contact.

In determining the location, thickness, and material of the protective structure 310, factors such as coefficients of thermal expansion, temperature gradients, and pitch angle may be considered. The thermal expansion may be greater for layers closer to the heat element 120, as closer layers may receive more heat. The thermal expansion may also be greater for materials with a higher coefficient of thermal expansion. The temperature gradients may vary depending on layer location with respect to the heat element 120 and materials of layers in between, as insulating layers may reduce heat received.

The pitch angle is an angle formed as the magnetic head 400 pivots down until making contact with the disk. Thus, a larger pitch angle may result in an outermost layer being more likely to make contact with the disk.

In various embodiments, some calibrations for thermal flying height operation have the magnetic head make contact with the disk by running a larger current through the heater. The large current pivots the magnetic head toward the disk until contact is made. As the protective structure 310 is first to contact the disk, the operational distances, flying heights, of the reader element 140 and the writer element 180 may be determined.

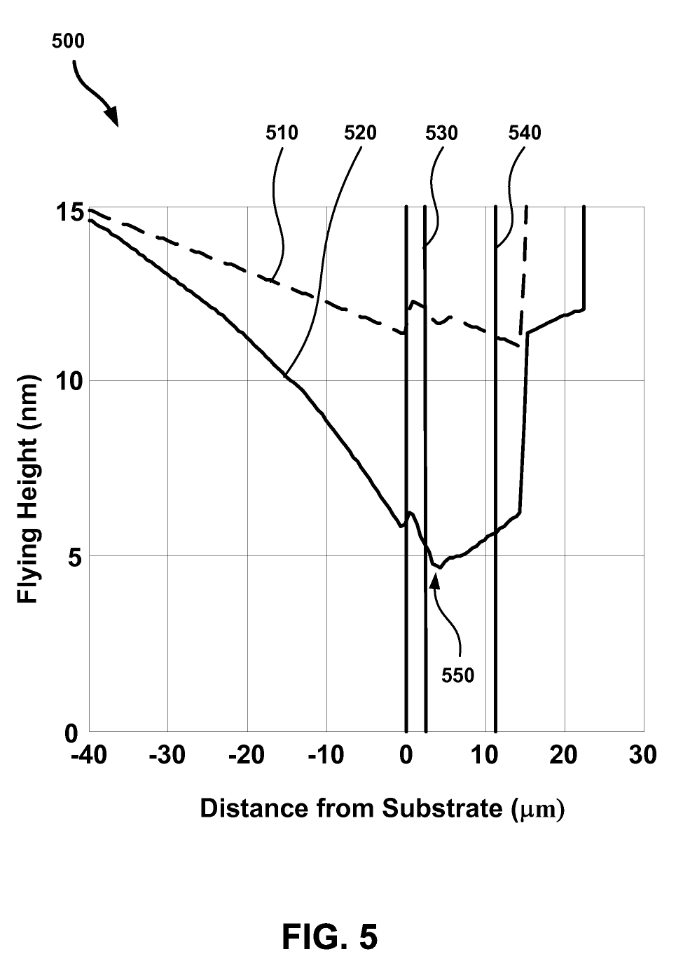

FIG. 5 is a graph 500 illustrating a flying-height profile for a magnetic head with a protective structure, in accordance with an embodiment of the present technology. The graph 500 comprises a standby height profile 510, a flying-height profile 520, a reader element location 530, a writer element location 540, and a region of probable contact 550. The standby height profile 510 shows a profile for a magnetic head while idle. The flying-height profile 520 shows a profile for a magnetic head during operation. The reader element location 530 shows a reader element approximately two micrometers from a substrate and approximately five nanometers from a disk surface. The region of probable contact 550 shows the reader element 140 to have an approximate one nanometer buffer due to the protection structure 310. In various embodiments, a protective distance is between 0.1 nanometer and 0.5 nanometers.

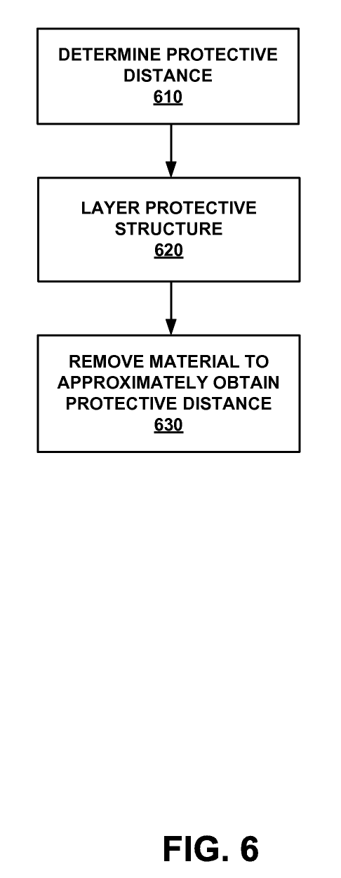

FIG. 6 is a flow diagram of an example method of manufacturing a magnetic head, in accordance with an embodiment of the present technology. In step 610, a protective distance for the protective structure 310 is determined. Determining the protective distance may factor pole-tip recession, coefficients of thermal expansion, temperature gradients, and/or the pitch angle.

In some embodiments, the protective distance is a distance determined parallel to the protective structure. In other embodiments, the protective distance is determined orthogonal to the disk. A difference between using a parallel-to-protective-structure approach as opposed to orthogonal-to-disk approach is the pitch angle consideration. In further embodiments, the protective distance is determined as if the protective structure is making contact with the disk. With this approach, the pitch angle may be used. Additionally, the protective distance may be determined based on the flying height or an idle state.

The protective distance may be referenced to the reader element and/or the writer element, independent of a closer element. In some embodiments, separate protective distances are determined for multiple protective structures.

In determining the protective distance, tables and/or benchmarking may be used. Tables may contain various material information regarding erosion/corrosion rates, pole-tip recession rates, coefficients of thermal expansion, and/or temperature gradients. Benchmarking may be conducted as a trial and error approach.

In step 620, the protective structure is layered. In step 630, material is removed to obtain approximately the protective distance. The material may be removed by lapping, and/or pre-carbon etching. In various embodiments, the operation height or flying height is determined partially based on the protective distance and/or the protective structure. By having the protective structure 310, the flying height may be narrower as a risk of element touching the disk is reduced.

The foregoing descriptions of example embodiments have been presented for purposes of illustration and description. They are not intended to be exhaustive or to limit the teaching to the precise forms disclosed. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of manufacturing a magnetic head comprising:
determining a protective distance for a protective structure to extend beyond an element in a direction toward a disk, wherein the protective distance is from an element end to a protective structure end, wherein the protective distance is based on a magnetic head profile;
layering the protective structure, wherein a thickness of the protective structure is based on pole-tip recession; and
removing material from the protective structure to obtain approximately the protective distance.

2. The method of claim 1, wherein the protecting structure comprises a material selected from a group consisting of silicon-carbon, and tungsten.

3. The method of claim 1, wherein the protective distance is determined parallel to the protective structure.

4. The method of claim 1, wherein the protective distance is determined orthogonal to the disk.

5. The method of claim 4, wherein the protective distance is determined as if the protective structure is making contact with the disk.

6. The method of claim 1, wherein the element is selected from a group consisting of a reader element, and a writer element.

7. The method of claim 1, further comprising another element, wherein the another element is farther from the disk during operation than the element.

8. The method of claim 1, wherein the removing of material is performed by a process selected from a group consisting of lapping, and pre-carbon etching.

9. The method of claim 1, wherein the protective distance is determined based on selected from a group consisting of tables, and benchmarking.

10. The method of claim 1, further comprising calibrating an operation height partially based on the protective structure.

11. A method of calibrating an operation distance for a magnetic head comprising:
determining a protective distance for a protective structure to extend beyond an element in a direction toward a disk, wherein the protective distance is from an element end to a protective structure end, wherein the protective distance is based on a magnetic head profile;
layering the protective structure, wherein a thickness of the protective structure is based on pole-tip recession;
removing material from the protective structure to obtain approximately the protective distance; and
calibrating an operation distance partially based on the protective structure.

12. The method of claim 11, further comprising calibrating a standby mode distance partially based on the protective distance.

13. The method of claim 11, wherein the protective distance is determined based on selected from a group consisting of tables, and benchmarking.

14. The method of claim 11, wherein the protecting structure comprises a material selected from a group consisting of silicon-carbon, and tungsten.

15. The method of claim 11, wherein the protective distance is determined parallel to the protective structure.

16. The method of claim 11, wherein the protective distance is determined orthogonal to the disk.

17. The method of claim 11, wherein the protecting structure comprises a material selected from a group consisting of silicon-carbon, and tungsten.

18. A magnetic head comprising:
a reader element;
a writer element; and
a protecting structure configured to make physical contact with a disk prior to either the reader element or the writer element from making physical contact with the disk, the protecting structure comprising a more resistant material to lapping than a material to be lapped used by the reader element.

19. The magnetic head of claim 18, wherein the protecting structure comprises a material selected from a group consisting of silicon-carbon, and tungsten.

20. The magnetic head of claim 18, wherein the protective structure is configured to create a protective distance between 0.1 nanometer and 0.5 nanometers.
